(19) United States
(12) Patent Application Publication
(10) Pub. No.: US 2022/0407738 A1
(43) Pub. Date: Dec. 22, 2022

(54) COMPUTING DEVICE FOR EXECUTING INDIRECT COMMANDS

(71) Applicant: International Business Machines Corporation, Armonk, NY (US)

(72) Inventors: Sarbajit K. Rakshit, Kolkata (IN); Manish Anand Bhide, Hyderabad (IN); Seema Nagar, Bangalore (IN); Madhavi Katari, Kondapur (IN); Kuntal Dey, Rampurhat (IN)

(21) Appl. No.: 17/354,525

(22) Filed: Jun. 22, 2021

(51) Int. Cl. H04L 12/28; H04L 29/08; G06F 11/34

(52) U.S. Cl. CPC H04L 12/2829; H04L 12/2818; H04L 67/2804; G06F 11/3457

(57) ABSTRACT

A processor may receive, by a computing device, the indirect command from a user. The indirect command may include an instruction to the computing device to collect an information dataset from a secondary source. A processor may analyze the information dataset from the secondary source. A processor may determine one or more actions to be performed. The one or more actions may be based, at least in part, on the information dataset from the secondary source. A processor may execute the one or more actions.

### BACKGROUND

The present disclosure relates generally to the field of artificial intelligence, and more particularly to the field of smart devices.

Computing devices or other smart devices have evolved over time to accomplish various tasks for humans, making our lives easier. Such devices can be found in people's homes and offices to assist people with some aspect of their day. As these devices have grown in popularity, so too has demand to make these devices more useful and able to enhance users' daily experience.

### SUMMARY

Embodiments of the present disclosure include a method, computer program product, and system for executing actions based on an indirect command. A processor may receive, by a computing device, the indirect command from a user. The indirect command may include an instruction to the computing device to collect an information dataset from a secondary source. A processor may analyze the information dataset from the secondary source. A processor may determine one or more actions to be performed. The one or more actions may be based, at least in part, on the information dataset from the secondary source. A processor may execute the one or more actions.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of an intelligent ecosystem, in accordance with the present disclosure.

FIG. 2 illustrates a flowchart of a method for executing actions based on an indirect command, in accordance with embodiments of the present disclosure.

FIG. 3A illustrates a cloud computing environment, in accordance with embodiments of the present disclosure.

FIG. 3B illustrates abstraction model layers, in accordance with embodiments of the present disclosure.

FIG. 4 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of artificial intelligence, and more particularly to smart devices. While the present disclosure is not necessarily limited to such applications, various aspects of the disclosure may be appreciated through a discussion of several examples using this context.

The demand for personal computing devices (e.g., smart devices) has risen significantly over the years as the usefulness of such devices has expanded into both a person's home and work-life. Often such devices connect to one or more other devices or networks, allowing the devices to interact with each other and provide more utility for a user. For example, a user of a smart device may be able to order a product from a website using voice commands and have the product shipped directly to them. The usefulness of such smart devices is compounded when combined with artificial intelligence (AI). Such AI enabled computing devices can be configured into a type of virtual assistant and generate an AI assistance system capable of performing complex tasks (e.g., tasks traditionally performed by a personal assistant).

Traditional AI assistance systems often include one or more computing devices or smart devices configured to receive one or more voice commands from a user and execute those activities or provide information to the user. Unfortunately, in many situations a user may not be able to or, due to other circumstances, want to provide voice commands to the particular device in the AI assistance system. For example, a user who has a AI assistance system configured within their home (e.g., an intelligent ecosystem) may know it may rain from 12:00 pm to 3:00 pm that day. As a result, the user can instruct the AI assistance system (e.g., via the smart device) to close smart/connected windows at 12:00 pm to ensure that no rainwater enters the internal structure of the home and to open the windows after 3:00 pm to ensure the house is well ventilated. While the usefulness of this system is obvious, such systems only work if the user knows the likelihood of rain and issues the command to the AI assistance system to open or close the windows. For example, if the user issues the command to the AI assistance system using outdated information for example, instead of the rain occurring between the hours of 12:00 pm and 3:00 pm the rain will now occur between 4:00 pm to 5:00 pm, the AI assistance system will continue to adhere to the user's commands and will open the window after 3:00 pm. The AI assistance system would unfortunately allow rainwater to enter the home and potentially cause structural damage. As such, there is a desire for a smart device (e.g., AI assistance system) capable of performing one or more actions based on indirect voice commands from a user.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow.

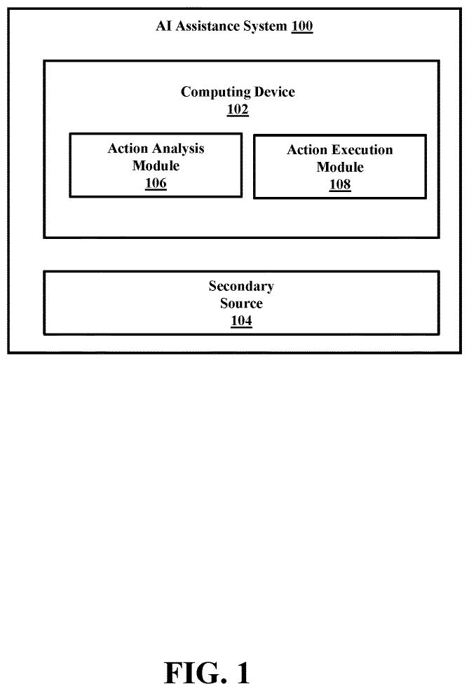

Also, any device depicted in the drawings can be a different device. For example, if a mobile device is shown sending information, a wired device could also be used to send the information. The term “module” may refer to a hardware module, software module, or a module may be a combination of hardware and software resources. Embodiments of hardware-based modules may include self-contained components such as chipsets, specialized circuitry, one or more memory devices and/or persistent storage. A software-based module may be part of a program, program code or linked to program code containing specifically programmed instructions loaded into a memory device or persistent storage device of one or more data processing systems operating as part of the computing environment (e.g., intelligent ecosystem 100). For example, data associated with action module 104, depicted in FIG. 1, can be loaded into memory or a database.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

In embodiments discussed herein, solutions are provided in the form of a method, system, and computer program product, for executing actions based on an indirect command to a computing device (e.g., AI assistance device). Embodiments contemplated herein enable a user to issue an indirect command to a computing device to analyze a secondary source of information and identify one or more appropriate actions based, at least in part, on the indirect command. Traditional AI assistance systems are configured to only receive direct commands. For example, a user may issue a direct voice command to the AI assistance system to “please turn on the kitchen light at 5:00 pm.” Such traditional AI assistance systems are only configured to perform actions associated with information directly related to the user's command.

Embodiments contemplated herein, allow for a computing device (e.g., AI assistance device) to receive an indirect command from a user and perform/execute actions (e.g., within an intelligent ecosystem) associated with information that is not directly related to the user's command. In embodiments, an indirect command may include one or more instructions from a user to collect information (e.g., in an information dataset) from a secondary source (e.g., a particular radio or television program). In such embodiments, the information dataset collected from the secondary source may be analyzed and used to determine one or more actions to be executed within an intelligent ecosystem.

In embodiments, the computing device (e.g., AI assistance device) may be configured to perform the functions via a processor of the computing device. For example, the computing device may be configured by a processor utilizing software, an application, etc. In some embodiments, a computing device may be configured with AI capabilities and function as an AI assistance device. The computing device may include, but is not limited to, devices such as, a smartwatch, voice assistant device (e.g., Google home®, Amazon Alexa®, Siri®, Bixby®, etc.), Internet of Things (IoT) device(s), any smart device, or any combination thereof. While embodiments herein often refer to a single computing device, any number of computing devices may be used, either independently or in concert with other computing devices. In addition, while various embodiments disclosed herein may make reference to a computing device configured as an AI assistance device (e.g., within an AI assistance system), such embodiments should not be construed as limiting and any computing device contemplated herein may be used with or without AI capabilities.

In embodiments, as referenced above, the computing device may be configured to receive one or more commands from one or more users (e.g., direct and indirect commands). The computing device may include any number of IoT devices and/or other sensors configured to receive and/or execute a user's commands. For example, in one exemplary embodiment, the computing device may be configured with at least a microphone and a speaker to detect and receive information (e.g., a voice command from a user). While embodiments contemplated herein often refer to the computing device as receiving voice commands (e.g., direct and indirect commands) from a user, the computing device may be configured to receive commands from a user in a variety of ways.

For example, while in some embodiments a user may issue a command as voice command, in other embodiments, a user may remotely issue commands to the computing device by interacting with an application on a different device (e.g., a mobile phone) configured to connect to the computing device. In this example, a user may be at a worksite and issue the command (e.g., verbally and/or in text, or through a configuration of settings) to a computing device configured within the home (e.g., an intelligent ecosystem of a smart home) via the application. In this example, a user could issue the command, either a direct command or indirect command, digitally through the application to the computing device to execute various actions.

In embodiments, the computing device may be configured within and/or connected to an intelligent ecosystem. An intelligent ecosystem may refer to any environment (e.g., a particular room, set of rooms, house, office building, conference room, etc.) having one or more other devices configured to connect to the computing device. For example, a computing device associated with an intelligent ecosystem may be configured to control and/or interact with various devices/aspects of the environments. These devices/aspects of the environment may include, but are not limited to, turning one or more utilities (e.g., water, gas, electricity, etc.) on or off at a particular location (e.g., filling a tank with drinking water), closing and/or opening different barriers of a building (e.g., opening the windows or doors of a smart building/house), and charging one or more batteries (e.g., batteries associated with wind and/or solar power).

In embodiments, a processor may analyze the one or more commands issued by the user and determine if the command is an indirect command or a direct command. As referenced herein, an indirect command from a user may include one or more instructions from the user to the computing device (e.g., configured by a processor) to collect an information dataset from a secondary source. A secondary source may include any additional source of information and produced in any media form (e.g., audio, textual, etc.). For example, a secondary source may include, but is not limited to a radio program, a cable television news program, a news reporting article published to a particular webpage, or any combination thereof. While embodiments contemplated herein often refer to the use of one secondary source, any number of secondary sources may be utilized (e.g., tertiary, quandary, etc.). Reference to a single secondary source is intended for brevity and clarity purposes only and should not be considered limiting.

In embodiments, a processor may analyze the one or more commands issued to the computing device and determine if the one or more users issuing the command has a valid permission level. In embodiments where a user has a valid permission level, a computing device can perform/execute actions in response to the command issued by the user. While in some embodiments, all of the persons issuing commands to the computing device may have a valid permission level (e.g., and considered users), in other embodiments, fewer than all persons issuing commands to the computing device may have a valid permission level. Alternatively, in some embodiments, some users may have a valid permission level to make some command types (e.g., direct commands) but may then lack valid permission associated with other particular command types (e.g., indirect commands). In various embodiments, a processor may determine if a user has a valid permission level in a variety of ways including, but not limited to, using AI capabilities, accessing a user profile, or a combination thereof.

In embodiments, a processor may have access to one or more user profiles associated with one or more users. In embodiments, a processor may access the one or more user profiles to identify the particular user and determine if the user has a valid permission level to issue the command and/or command type to the computing device. A user profile may have one or more identity components a processor may utilize to confirm a user's identity. Identity components may include, but are not limited to, voice identifying data, face identifying data, and device identifying data (e.g., IP address associated with a particular device). For example, a processor may be configured to analyze a user's voice (e.g., analyzing the power bandwidth of the voice) and identify the user (e.g., using voice recognition techniques) using voice identifying data compiled in a user profile. In embodiments, a user profile may also include information regarding the user's permission level. For example, the profile may indicate whether the user has a valid permission level to issue any and all commands, or if the user is limited to only being able to issue one particular command type.

While in some embodiments, an administrator may compile and generate a user profile, in other embodiments, a user profile may be generated using historical data collected by a processor (e.g., via a computing device) associated with the intelligent ecosystem. For example, in some embodiments, a processor may be configured to use AI and machine learning techniques to identify and differentiate persons who commonly interact with the intelligent ecosystem from those persons who may be temporarily occupying the intelligent ecosystem. In these embodiments, a processor may determine those persons who commonly interact with the intelligent ecosystem are users and generate a user profile based, at least in part, on the data collected over a period of time (e.g., historical data). For example, in a smart home (e.g., intelligent ecosystem) a person who lives in the home may be considered a user and have valid permission level to issue indirect commands to the computing device, while a guest visiting the smart home may be recognized as a new person and will not have valid permission to issue indirect commands.

In an embodiment, a user of a computing device configured within their smart home (e.g., an intelligent ecosystem) could issue an indirect command to the computing device via a voice command. An example of an indirect command from the user (e.g., having a valid permission level) could be, “please listen to the weather forecast report by meteorologist Jane Doe and perform actions to prepare the home for the upcoming weather.” In embodiments, a processor may analyze the indirect command issued by the user (e.g., using AI capabilities). In these embodiments, a processor may identify one or more particular topics from the indirect command that indicate key words and/or relevant portions of the indirect command. In embodiments, a processor may be configured with AI capabilities to analyze and identify the one or more particular topics from the indirect command. Using the above example embodiments, a processor could identify the one or more particular topics from the indirect command as “weather forecast report,” “meteorologist Jane Doe,” and “prepare the home for the upcoming weather.”

In embodiments, a processor (e.g., via a computing device) may collect a plurality of content generated by a secondary source. The plurality of content may include any and/or all information/data associated with the secondary source. Continuing the above example embodiment, the weather forecast report by meteorologist Jane Doe could include weather reports for the entire state the home is located in. In this example embodiment, the plurality of content generated by the secondary source (e.g., weather forecast report) and collected by the computing device may include the multiple weather forecasts associated with different areas across the state, and not just the particular location the home is located at.

In embodiments, a processor may analyze a plurality of content generated by the secondary source. In these embodiments, a processor may analyze and determine if some or all of the plurality of content (e.g., generated by the secondary source) is associated with (e.g., correlates with) the one or more particular topics identified from indirect command. By analyzing and correlating the plurality of content and the one or more particular topics, a processor may identify an information dataset from the plurality of content. In embodiments, the information dataset may include the relevant information/data associated with the indirect command of the user. Continuing the above example embodiment, if the weather report by meteorologist Jane Doe includes various weather forecasts for different areas across the state (e.g., plurality of content) and the indirect command from the user indicates the weather forecast associated with the location of the user's home (one or more particular topics) is needed, the processor may analyze this information/data and identify the information dataset. In this simplified example, the information dataset may include Jane Doe's weather forecast (e.g., if there is an expectation of rain, time/duration of expected rain, and amount of rain) of the particular area associated with the location of the user's home.

In some embodiments, a processor may be configured to recognize the secondary source. For example, in embodiments where a secondary source is a weather forecast, a processor may use voice recognition to identify the meteorologist's voice. In these embodiments, the processor could identify the secondary source among other voices that could be present in the weather forecast (e.g., the anchor of the news program that the weather report is part of). In these embodiments, a processor may begin collecting and/or analyzing once the secondary source is recognized (e.g., when meteorologist Jane Doe begins speaking).

In some embodiments, a processor may place the computing device into a sleep mode to save one or more resources (e.g., electricity) when not in use. In these embodiments, a processor may initiate the computing device to exit sleep mode (e.g., awaken mode) when the processor detects the secondary source (e.g., using voice recognition). In other embodiments, a processor may be activated (e.g., awake mode) at a particular time or after a duration of time. For example, if the weather report is scheduled for 10:00 AM a processor may initiate sleep mode and activate or enter awake mode at 10:00 am to allow the processor to collect the information dataset from the weather report (e.g., secondary source).

In embodiments, a processor may analyze the information dataset collected from the secondary source. In such embodiments, a processor may use AI capabilities to analyze the information dataset. From this analysis, a processor may determine one or more actions to be performed in order to comply with the indirect command. In some embodiments, a processor may analyze and determine the one or more actions to be performed by analyzing and/or simulating an impact of the information dataset on the intelligent ecosystem. While such analyses may be configured in a number of different ways, one such technique may include a processor generating a digital twin of the intelligent ecosystem (e.g., using a AI enabled digital twin simulation engine) and simulating how the information dataset collected from the secondary source may impact the intelligent ecosystem.

In an example embodiment, an intelligent ecosystem may be configured inside a home and be connected to devices that control the opening and closing of windows, water collection tanks, opening and closing of storm shutters, and a solar system having solar panels and a solar battery. In some embodiments, a processor may collect real-time information associated with the intelligent ecosystem from one or more data collection devices (e.g., IoT devices). For example, a processor may collect information from the intelligent ecosystem including, but not limited to, current status of barriers (e.g., whether windows/garage door are open or closed), how full are the water tanks, and current battery levels. In embodiments, a processor may analyze this information to generate an understanding of the structure and capabilities of the intelligent ecosystem. In some embodiments, this analysis may be based, at least in part, on the generation of a digital twin of the intelligent ecosystem that may mimic different aspects of the intelligent ecosystem.

Continuing this example, the information dataset collected from Jane Doe's weather report could include information indicating that sunshine is expected from 12:00 PM to 1:30 PM, heavy rain with high speed winds are expected between 2:00-6:00 PM with possible loss of power. In some embodiments, a processor could analyze and determine what devices within the intelligent ecosystem may be impacted by the information dataset. Some devices or components configured/controlled by the intelligent system may not be relevant to some information datasets, while others may play a key role. For example, whether a kitchen light is on or off is unlikely to impact the intelligent ecosystem during a storm, but if a window is left open during the same rainstorm could impact the intelligent ecosystem and cause structural damage (e.g., water damage) to the home.

In an example intelligent ecosystem, a processor could identify that based on the weather report that the devices/components that may be relevant are the windows, storm shutters, solar panels, solar battery, and a water tank. Using the one or more data collection devices, a processor could determine the current status of these relevant devices/components. For example, the processor could determine that the storm shutters and windows are presently open, a solar battery associated with a solar system is 50% charge, and the water tank is empty.

In this example embodiment, a processor may analyze (e.g., using a digital twin) an impact associated with the collected weather report. For example, a processor could analyze the effect of opening and closing the windows while the sun is shining from 12:00-1:30 PM and determine if leaving the windows open or if opening the windows for a short period of time could improve ventilation or increases/decreases the temperature of the house (e.g., as considered desirable by a user). In another example, a processor could analyze the impact of how much charge a solar battery may obtain during the period of sunshine, how long the solar battery charge might last if power to the intelligent ecosystem is lost, and/or whether charging the solar battery is optimal for increasing the life of the solar battery. While embodiments herein often refer to an intelligent ecosystem having a solar panel system, such intelligent ecosystems may also, either alternatively or additionally, include wind power systems having batteries and wind turbines (e.g., which may be used during periods having high winds). In another example, a processor may simulate how the high speed winds affect the intelligent ecosystem (e.g., if the storm shutters are needed).

In embodiments, a processor may utilize the herein contemplated analyses (e.g., digital twin) to determine one or more actions to be performed/executed (e.g., based on the information dataset and the secondary source). In embodiments, the one or more actions may include how the intelligent ecosystem may take advantage of the information dataset. While in some embodiments the one or more actions activities associated with preventing damage to the intelligent ecosystem (e.g., smart home), in other embodiments, the one or more actions may be associated with performing sustainability activities.

Continuing the above example, based on the analyses performed a processor could determine that one or more actions should be performed as a result of Jane Doe's weather report. For example, during the 12:00-1:30 PM period of sunshine, the solar battery should be charged (e.g., to prepare for potential loss of electricity/power) and the windows should be opened. In addition, a processor could determine that during the 2:00-6:00 PM period of heavy rain and high wind, the windows and the storm shutters should be closed and the water tanks should be configured (e.g., valve opened) to collect rainwater.

In embodiments where a processor has determined the one or more actions that should be performed within the intelligent ecosystem, a processor may execute all, or less than all of the one or more actions. In some embodiments, the one or more actions may be initiated at a particular time. In these embodiments, the particular time may be based, at least in part, on the information dataset. For example, in the above example embodiment, based on the weather changes communicated by the weather report (e.g., information dataset), the windows are opened from 12:00-1:30 PM but are then closed from at least, 2:00-6:00 PM. In some embodiments, after the one or more actions have been executed, a processor may execute other actions. These other actions may include a reset of some of the relevant devices/components of the intelligent ecosystem. For example, the intelligent ecosystem may automatically open the storm shutters after 6:00 PM since the time associated with the need for such actions has lapsed. In other embodiments, a processor may determine and execute other actions. For example, after 6:00 PM the intelligent ecosystem may open the storm shutters to allow light into the smart home and close off the water tank (e.g., close valve) to prevent water contamination.

In some embodiments, a processor may receive an information dataset from the secondary source and the secondary source may indicate that a tertiary source may be accessed to generate a supplemental information dataset. In some embodiments, after a tertiary source, a processor could access additional sources of information (e.g., quaternary source) until a limit or a threshold number of handoffs between sources has been exceeded. In embodiments, a transition counter may be used to determine if the threshold number of handoffs has been exceeded. In some embodiments, this threshold number of handoffs may be determined by the user, but may also be determined by the accessibility of the source. For example, if the tertiary source is not available to the processor, the processor may determine/identify the one or more actions based on the secondary source alone. In some embodiments, these handoffs can be cyclic and can be recurrent in nature. In some embodiments, the handoffs (e.g., secondary sources to tertiary source) will only be allowed within pre-permissioned sources (e.g., verified sources and not obscure website sources). In some embodiments, a user may further impose constraints on which commands may or may not be accepted by the processor (e.g., when there is a multi-level handoff that exceeds a threshold). In embodiments where a handoff threshold is exceeded and the collected information dataset is does not contain sufficient information determine one or more actions, a processor may prompt the user to provide more information. For example, a processor may send a message (e.g., a text message to the user's mobile device) stating additional information is necessary to perform one or more actions. Alternatively, in some embodiments where there is insufficient information, a processor may determine that no actions are necessary to conform to the user's indirect command.

Referring now to FIG. 1, a block diagram of an intelligent ecosystem 100 for executing actions based on an indirect command, is depicted in accordance with embodiments of the present disclosure. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims. In some embodiments, the solar panels may be directed by the computing device to move to a more advantageous angle.

In embodiments, AI assistance system 100 may include computing device 102 and secondary source 104. Computing device 102 (e.g., AI voice assistance device) may be configured to receive an indirect command from a user. As contemplated herein, the indirect command may include an instruction to the computing device to collect and information dataset from secondary source 104. In embodiments, computing device 102 may include an action analysis module 106 and action execution module 108. Action analysis module 106 may be configured to analyze the information data set from the secondary source 104 to determine one or more actions to be performed by the computing device 102 (e.g., within the intelligent ecosystem). In embodiments, Action execution module 108 may be configured to receive the one or more actions determined by action analysis module 106 and perform or execute the one or more actions in the intelligent ecosystem.

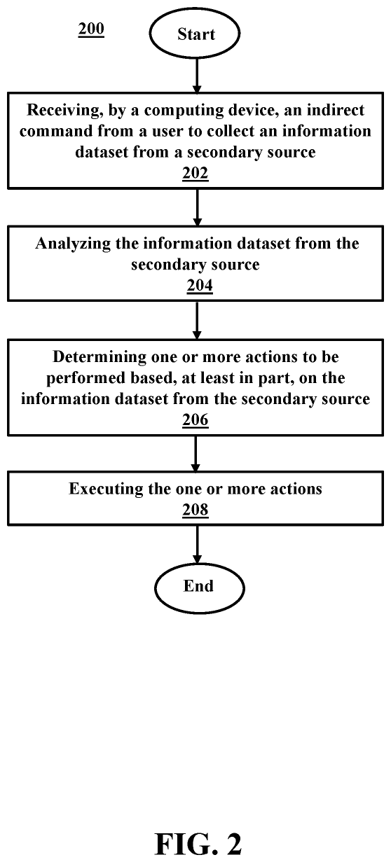

Referring now to FIG. 2, a flowchart illustrating an example method 200 for executing actions based on an indirect command, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202 where a processor configures a computing device to receive an indirect command from a user. In embodiments, the indirect command may include an instruction to the computing device to collect an information dataset from a secondary source. In some embodiments, the method 200 proceeds to operation 204.

At operation 204, a processor may analyze the information dataset from the secondary source. In some embodiments, the method 200 proceeds to operation 206.

At operation 206, a processor may determine one or more actions to be performed. In some embodiments, the one or more actions may be based, at least in part, on the information dataset from the secondary source. In some embodiments, the method 200 proceeds to operation 208.

At operation 208, a processor may execute the one or more actions. In some embodiments, as depicted in FIG. 2, after operation 208, the method 200 may end.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

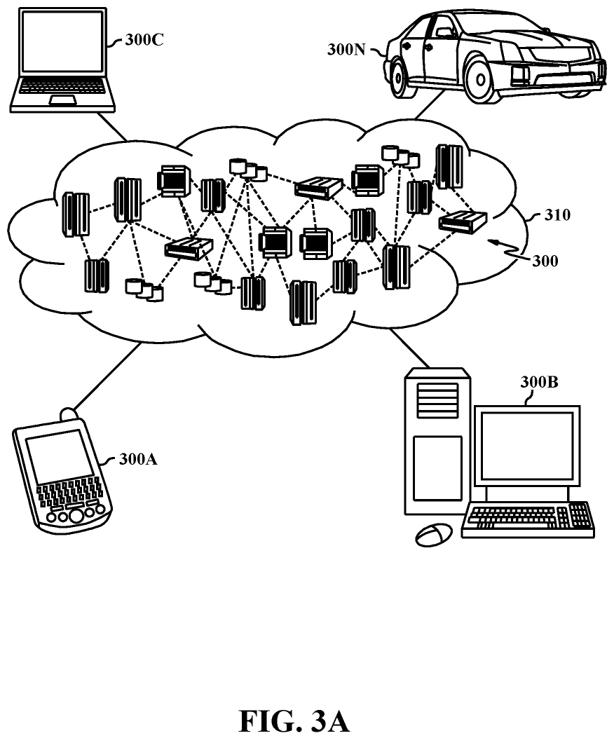

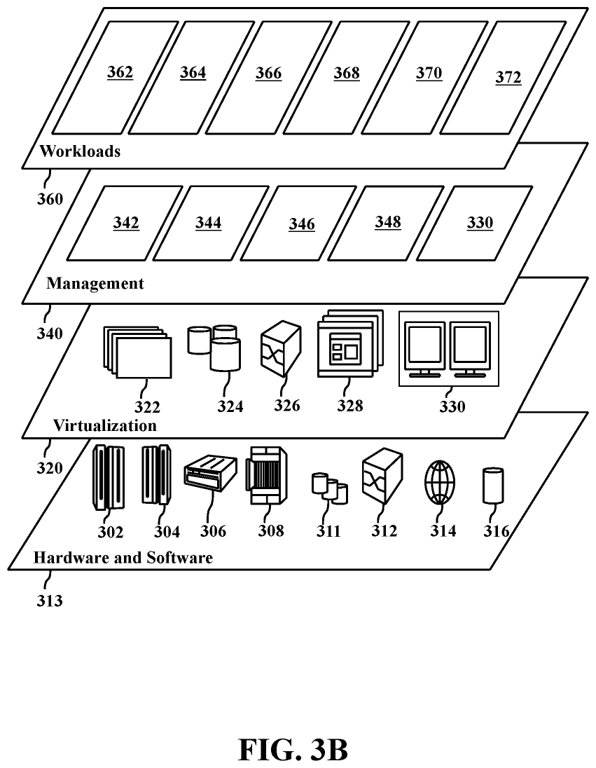

Referring now to FIG. 3A, illustrative cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof. This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing 300 and cloud computing environment 310 can communicate with any type of computerized device over any type of network and/or network addressable connection (e.g., using a web browser).

Referring now to FIG. 3B, a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and indirect command executing 372.

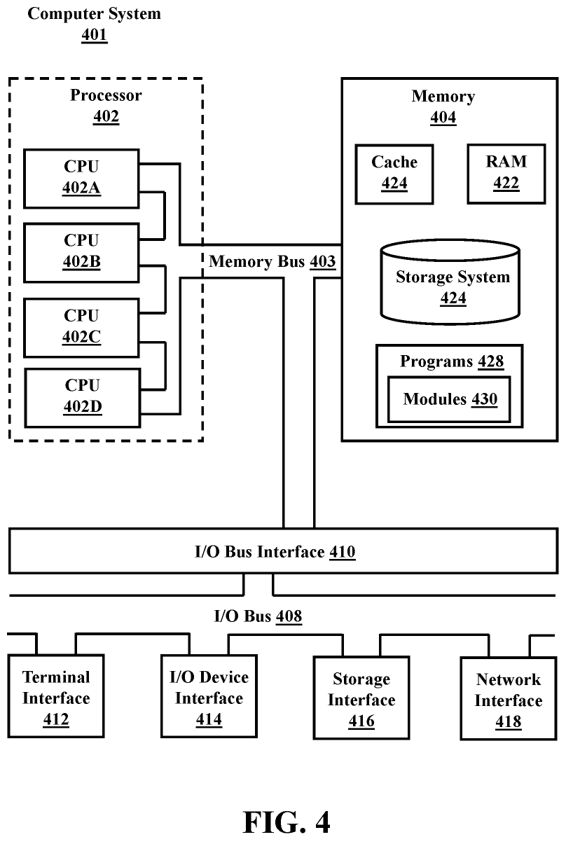

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present invention. In some embodiments, the major components of the computer system 401 may comprise one or more Processor 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A method for executing actions based on an indirect command, the method comprising:
receiving, by a computing device, one or more commands from a user, wherein the one or more commands are associated with an intelligent ecosystem having one or more devices;
analyzing the one or more commands to determine whether the one or more commands is a direct command or an indirect command;
identifying the indirect command from the one or more commands, wherein the indirect command includes an instruction to the computing device to collect an information dataset from a secondary source associated with an audio producing device;
analyzing one or more audio sources generated by the audio producing device for the secondary source;
determining the secondary source is a pre-permissioned source, wherein the pre-permissioned source is a verified source;
analyzing the information dataset from the secondary source;
identifying one or more actions to be performed in the intelligent ecosystem, wherein the one or more actions are based, at least in part, on the information dataset from the secondary source; and
performing the one or more actions, in response to identifying the one or more actions to be performed in the intelligent ecosystem, using the one or more devices, wherein performing the one or more actions changes the state of at least one of the one or more devices from a first state to a second state.

2. The method of claim 1, further comprising:
determining the user is an valid permissioned user, wherein the valid permissioned user is determined based, at least in part, on the indirect command from the user to the computing device.

3. The method of claim 1, further comprising:
analyzing the indirect command from the user;
identifying one or more particular topics from the indirect command, wherein the information dataset is based, at least in part, on the one or more particular topics identified.

4. The method of claim 3, further comprising:
analyzing a plurality of content generated by the secondary source; and
determining if the plurality of content generated by the secondary source is associated with the one or more particular topics identified from the indirect command.

5. The method of claim 4, wherein responsive to determining if the plurality of content generated by the secondary source is associated with the one or more particular topics includes:
identifying the information dataset from the plurality of content, wherein the information dataset includes information associated with the indirect command.

6. The method of claim 1, wherein determining one or more actions to be performed includes:
simulating an impact of the information dataset on the intelligent ecosystem, wherein the simulation generates the one or more actions.

7. The method of claim 1, wherein executing the one or more actions includes:
initiating the one or more actions at a particular time, wherein the particular time is based, at least in part, on the information dataset.

8. A system for executing actions based on an indirect command, the system comprising:
a memory; and
a processor in communication with the memory, the processor being configured to perform operations comprising:
receiving one or more commands from a user, wherein the one or more commands are associated with an intelligent ecosystem having one or more devices;
analyzing the one or more commands to determine whether the one or more commands is a direct command or an indirect command;
identifying the indirect command from the one or more commands, wherein the indirect command includes an instruction to the computing device to collect an information dataset from a secondary source associated with an audio producing device;
analyzing one or more audio sources generated by the audio producing device for the secondary source;
determining the secondary source is a pre-permissioned source, wherein the pre-permissioned source is a verified source;
analyzing the information dataset from the secondary source;
identifying one or more actions to be performed in the intelligent ecosystem, wherein the one or more actions are based, at least in part, on the information dataset from the secondary source; and
performing the one or more actions, in response to identifying the one or more actions to be performed in the intelligent ecosystem, using the one or more devices, wherein performing the one or more actions changes the state of at least one of the one or more devices from a first state to a second state.

9. The system of claim 8, further comprising:
determining the user is an authorized user, wherein the authorized user is determined based, at least in part, on the indirect command from the user to the computing device.

10. The system of claim 8, further comprising:
analyzing the indirect command from the user;
identifying one or more particular topics from the indirect command, wherein the information dataset is based, at least in part, on the one or more particular topics identified.

11. The system of claim 10, further comprising:
analyzing a plurality of content generated by the secondary source; and
determining if the plurality of content generated by the secondary source is associated with the one or more particular topics identified from the indirect command.

12. The system of claim 11, wherein responsive to determining if the plurality of content generated by the secondary source is associated with the one or more particular topics includes:
identifying the information dataset from the plurality of content, wherein the information dataset includes information associated with the indirect command.

13. The system of claim 8, wherein determining one or more actions to be performed includes:
simulating an impact of the information dataset on the intelligent ecosystem, wherein the simulation generates the one or more actions.

14. The system of claim 8, wherein executing the one or more actions includes:
initiating the one or more actions at a particular time, wherein the particular time is based, at least in part, on the information dataset.

15. A computer program product for executing actions based on an indirect command, the computer program product comprising a computer readable storage medium having program instructions embodied therewith, the program instructions executable by a processor to cause the processors to perform a function, the function comprising:
receiving one or more commands from a user, wherein the one or more commands are associated with an intelligent ecosystem having one or more devices;
analyzing the one or more commands to determine whether the one or more commands is a direct command or an indirect command;
identifying the indirect command from the one or more commands, wherein the indirect command includes an instruction to the computing device to collect an information dataset from a secondary source associated with an audio producing device;
analyzing one or more audio sources generated by the audio producing device for the secondary source;
determining the secondary source is a pre-permissioned source, wherein the pre-permissioned source is a verified source;
analyzing the information dataset from the secondary source;
identifying one or more actions to be performed in the intelligent ecosystem, wherein the one or more actions are based, at least in part, on the information dataset from the secondary source; and
performing the one or more actions, in response to identifying the one or more actions to be performed in the intelligent ecosystem, using the one or more devices, wherein performing the one or more actions changes the state of at least one of the one or more devices from a first state to a second state.

16. The computer program product of claim 15, further comprising:
determining the user is an authorized user, wherein the authorized user is determined based, at least in part, on the indirect command from the user to the computing device.

17. The computer program product of claim 15, further comprising:
analyzing the indirect command from the user;
identifying one or more particular topics from the indirect command, wherein the information dataset is based, at least in part, on the one or more particular topics identified.

18. The computer program product of claim 17, further comprising:
analyzing a plurality of content generated by the secondary source; and
determining if the plurality of content generated by the secondary source is associated with the one or more particular topics identified from the indirect command.

19. The computer program product of claim 18, wherein responsive to determining if the plurality of content generated by the secondary source is associated with the one or more particular topics includes:
identifying the information dataset from the plurality of content, wherein the information dataset includes information associated with the indirect command.

20. The computer program product of claim 15, wherein determining one or more actions to be performed includes:
simulating an impact of the information dataset on the intelligent ecosystem, wherein the simulation generates the one or more actions.
